(19) United States
(12) Patent Application Publication
(10) Pub. No.: US 2017/0293351 A1
(43) Pub. Date: Oct. 12, 2017

(54) HEAD MOUNTED DISPLAY LINKED TO A TOUCH SENSITIVE INPUT DEVICE

(71) Applicant: Ariadne's Thread (USA), Inc. (DBA Immerex), Solana Beach, CA (US)

(72) Inventor: Adam LI, Solana Beach, CA (US)

(73) Assignee: Ariadne's Thread (USA), Inc. (DBA Immerex), Solana Beach, CA (US)

(21) Appl. No.: 15/093,410

(22) Filed: Apr. 7, 2016

(51) Int. Cl. G06F 3/01; G06F 3/0488; G02B 27/01; G06F 3/041

(52) U.S. Cl. CPC G06F 3/012; G06F 3/041; G06F 3/04883; G02B 27/017

(57) ABSTRACT

A system that accepts and displays user input from a touch sensitive input device, such as phone touchscreen, while a user is wearing a head mounted display. Since the user cannot directly observe the input device, the system generates a virtual touchscreen graphic showing the location of the user's touch, and displays this graphic on the head mounted display. This graphic may include a virtual keyboard. Embodiments may recognize specific gestures to initiate input, which cause the virtual touchscreen graphic to be displayed on the display, for example as an overlay onto the normal display. The virtual touchscreen graphic may be removed automatically when the system recognizes that an input sequence is complete. The input device may also have position and orientation sensors that can be used for user input, for example to control a tool or weapon in a virtual environment or a game.

### BACKGROUND OF THE INVENTION

### Field of the Invention

One or more embodiments of the invention are related to the field of virtual reality systems. More particularly, but not by way of limitation, one or more embodiments of the invention enable a head mounted display that receives and displays input commands from a touch sensitive input device linked to the display.

### Description of the Related Art

Virtual reality systems are known in the art. Such systems generate a virtual world for a user that responds to the user's movements. Examples include various types of virtual reality headsets and goggles worn by a user, as well as specialized rooms with multiple displays. Virtual reality systems typically include sensors that track a user's head, eyes, or other body parts, and that modify the virtual world according to the user's movements. The virtual world consists of a three-dimensional model, computer-generated or captured from real-world scenes. Images of the three-dimensional model are generated based on the user's position and orientation. Generation of these images requires rendering of the three-dimensional model onto one or more two-dimensional displays. Rendering techniques are known in the art and are often used for example in 3D graphics systems or computer-based games, as well as in virtual reality systems.

A challenge for virtual reality systems is obtaining input from the user of the system. Because the user may for example wear goggles or a headset that covers the user's eyes, he or she may not be able to see a keyboard, mouse, touchpad, or other user input device. Some providers of virtual reality systems have attempted to create specialized user input devices that a user can operate without seeing the device. For example, an input device may have a small number of buttons that a user can find and identify by feel. However, these devices typically have limited functionality due to the small number of fixed controls, and due to the lack of visual feedback to the user.

A touchscreen is a flexible, intuitive user input device that is increasingly incorporated into mobile phones and tablet computers. It provides immediate visual feedback to the user since the display and the input device (the touch sensors) are fully integrated. However, current touchscreens cannot be used with virtual reality displays since the user cannot see the touchscreen while wearing the headset. There are no known systems that combine the flexibility of touchscreen input with a head mounted display like a virtual reality headset.

For at least the limitations described above there is a need for a head mounted display, such as a virtual reality headset, linked to a touch sensitive input device, such as a touchscreen of a mobile phone or a tablet.

### BRIEF SUMMARY OF THE INVENTION

One or more embodiments described in the specification are related to a head mounted display linked to a touch sensitive input device. A user wearing a head mounted display, who may not be able to observe an input device, touches the surface of the input device to provide input. Visual feedback of the touch is generated and displayed on the head mounted display.

One or more embodiments of the invention may include a head mounted display with a mount worn by a user, and a display attached to the mount. For example, the head mounted display may be a virtual reality headset or virtual reality goggles. The system may be linked to a touch sensitive input device with a touch sensitive surface. Touch data may be transmitted from the touch sensitive input device to a communications interface, which may forward the data to a command processor and to a display renderer. The command processor may analyze the touch data to generate one or more input commands. The display renderer may generate one or more display images for the head mounted display. Based on the touch data, the display renderer may also generate a virtual touchscreen graphic, which for example may show the location of the user's touch on the touch sensitive surface. The display renderer may then integrate the virtual touchscreen graphic into the display image, for example as an overlay, and transmit the modified display image to the head mounted display.

In one or more embodiments the touch sensitive input device may be for example a touchscreen of a mobile device, such as mobile phone, smart phone, smart watch, or tablet computer. The mobile device may for example transmit touch data wirelessly to the communications interface, or using any wired or wireless network or networks.

In one or more embodiments, the display renderer may generate images of a virtual reality environment. Based on input commands generated from the touch data, the display renderer may modify the virtual reality environment, or it may modify the user's viewpoint of the environment.

In one or more embodiments a virtual touchscreen graphic may be generated and displayed only as needed, for example in response to a gesture that indicates the start of user input. It may be removed from the display image when user input is completed. For example, the command processor may recognize that a user input session is complete, and may therefore transmit a signal to the display renderer indicating that the virtual touchscreen graphic can be removed from the display image.

In one or more embodiments the virtual touchscreen graphic may include a virtual keyboard. As a user touches a location on the touch sensitive surface, the corresponding key on the virtual keyboard may be highlighted. As the user moves the location of the touch, the virtual touchscreen graphic may be updated to show the new location.

In one or more embodiments a user input command may be generated when the user removes contact with the touch sensitive surface. This approach may allow a user to make an initial contact with the surface without knowing precisely whether the location of contact is correct, and to then slide the contact into the correct position while receiving visual feedback from the virtual touchscreen graphic.

In one or more embodiments the touch sensitive input device may detect items that are proximal to the touch sensitive surface, in addition to or instead of detecting items that make physical contact with the surface. The display renderer may indicate proximal items in the virtual touchscreen graphic, such as for example showing the location of a finger that is hovering over, but not touching the touch sensitive surface.

In one or more embodiments the touch sensitive input device may have one or more feedback mechanisms, such as for example haptic feedback or audio feedback (such as speakers). The display renderer may calculate feedback signals, based for example on the location of the user's touch on the touch sensitive surface, and transmit these feedback signals to the touch sensitive input device. Feedback signals may for example guide a user to one or more locations on the surface.

In one or more embodiments the touch sensitive input device may have one or more sensors that measure aspects of the position or orientation of the device. Position or orientation data (or both) may be transmitted from the input device to the communications interface, and may be forwarded (or transformed and forwarded) to the display renderer and the command processor. The display renderer may generate a virtual implement graphic, such as for example a visual representation of a tool or a weapon in a game, based on the position and orientation data, and it may integrate this graphic into the display image. The display renderer may modify any visual characteristic of the virtual implement graphic based on the position and orientation, such as for example, without limitation, the size, shape, position, orientation, color, texture, or opacity of the graphic.

### BRIEF DESCRIPTION OF THE DRAWINGS

The above and other aspects, features and advantages of the invention will be more apparent from the following more particular description thereof, presented in conjunction with the following drawings wherein:

FIG. 1 shows a block diagram of one or more embodiments of the invention; components include a head mounted display, a touch sensitive input device, a communication interface and a command processor to receive and process touch data, and a display renderer to generate input controls and render images.

FIG. 2 illustrates an embodiment that processes an input command from a touchscreen to select a virtual reality environment.

FIG. 3 illustrates an embodiment that processes input commands to select a user's location in a virtual environment, or to select a weapon for a game in the virtual environment.

FIG. 4 illustrates an embodiment that generates a virtual keyboard linked to a touch device and displayed on a headset display.

FIG. 5 continues the example of FIG. 4 to show how user touch gestures are interpreted and displayed as keystrokes on the virtual keyboard linked to the touch device.

FIG. 6 illustrates a variation of the example of FIG. 5, with a touch sensitive device that detects proximity in addition to contact, and that provides haptic and audio feedback.

FIG. 7 illustrates an embodiment that uses position and orientation data from sensors in the touch sensitive input device to generate and control a virtual implement that is shown on the display of the headset.

### DETAILED DESCRIPTION OF THE INVENTION

A head mounted display linked to a touch sensitive input device will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

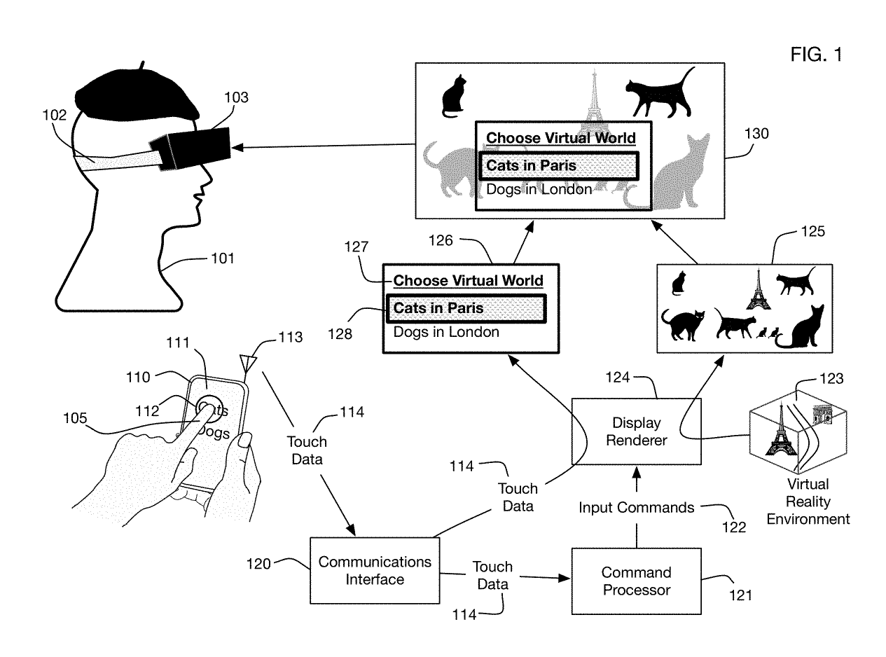

FIG. 1 shows a block diagram of components of one or more embodiments of the invention. User 101 wears head mounted device 102, which may for example be a virtual reality headset, virtual reality goggles, smart glasses, or any other device that contains a display 103 viewable by the user. One or more embodiments may use multiple displays, for example one for each eye of the user. One or more embodiments may use a display or displays viewable by the user, but not on a head mounted device, such as a display or displays on a wall. One or more embodiments may use displays worn on or integrated into the user's eye or eyes.

The user uses device 110 to provide user input to the system. In the embodiment shown, device 110 is a mobile phone. One or more embodiments may use any device or devices for user input, including for example, without limitation, a mobile phone, a smart phone, a tablet computer, a graphics pad, a laptop computer, a notebook computer, a smart watch, a PDA, a desktop computer, or a standalone touch pad or touch screen. Device 110 has a touch sensitive surface 111, which in the illustrative embodiment of FIG. 1 is the touchscreen of mobile device 110. The user provides input by touching (or by being in close proximity to) the touch sensitive area 111, for example with finger 105. The touch sensitive area may sense contact of an item with the surface, and in one or more embodiments it may also sense proximity of an item to the surface even if contact is not made. One or more embodiments may use any touch technology, including for example, without limitation, capacitive touch sensing and resistive touch sensing. In one or more embodiments the touch sensitive surface may be integrated with a display, as in a touchscreen for example. In one or more embodiments the touch sensitive surface may not include a display, as in a touch pad for example.

Touch data 114 is transmitted from touch sensitive input device 110 to a communications interface 120 that receives the data. One or more embodiments may use any wired or wireless network, or combinations of any networks of any types, to transmit touch data 114 from the touch sensitive input device 110 to the receiving communications interface 120. In the illustrative embodiment of FIG. 1, touch data 114 is transmitted via antenna 113 of mobile device 110 over a wireless network to communications interface 120. Touch data may be transmitted in any desired format. For example, it may contain x and y locations of a touch, and in one or more embodiments may also include additional data such as contact pressure. If the touch sensitive surface senses proximity in addition to (or instead of) contact, the touch data may include locations or areas of the surface that are in proximity to an item, and potentially may include data on the distance between an item and the surface. One or more embodiments may support multi-touch devices and may therefore transmit multiple simultaneous touch positions in touch data 114.

Communications interface 120 forwards touch data 114 to command processor 121 and to display renderer 124. In one or more embodiments the communications interface may filter, augment, or otherwise transform touch data 114 in any manner prior to forwarding it to the other subsystems. Command processor 121 analyzes touch data 114 to determine whether the user has entered one or more input commands. Input commands 122 detected by command processor 121 are forwarded to display renderer 124. Display renderer 124 also receives touch data 114.

Display renderer 124 generates display images for display 103. In one or more embodiments display images may be generated from a virtual reality environment 123. In one or more embodiments display images may be obtained from recorded video or images. In one or more embodiments display images may be captured live from one or more cameras, including for example cameras on head mounted device 102. One or more embodiments may combine rendering, recorded images or video, and live images or video in any manner to create a display image.

The display renderer 124 generates a virtual touchscreen graphic 126 that is integrated into the display image shown on display 103. This virtual touchscreen graphic may provide visual feedback to the user on whether and where the user is touching the touch sensitive surface 111 of the input device 110. In one or more embodiments it may provide feedback on other parameters such as for example the pressure with which a user is touching the surface. For example, in one or more embodiments some or all of the pixels of virtual touchscreen graphic 126 may correspond with locations on touch sensitive surface 111. In one or more embodiments the display renderer may map locations of the surface 111 to pixels of the virtual touchscreen graphic 126 in any desired manner. For example, the size and shape of the virtual touchscreen graphic 126 may be different from the size and shape of the surface 111. The mapping from surface locations to virtual touchscreen graphic pixels may or may not be one-to-one. One or more embodiments may generate icons, text, colors, highlights, or any graphics on the virtual touchscreen graphic 126 based on the Touch Data 114, using any desired algorithm to represent touch data visually on the virtual touchscreen graphic. In one or more embodiments parts of the virtual touchscreen graphic may not correspond directly to locations on the touch sensitive surface. For example, in the embodiment of FIG. 1, the header 127 in virtual touchscreen graphic 126 may not correspond to any location on the surface 111. The highlighted area 128 corresponds to the location 112 that is currently touched by the user's finger 105. As the user moves finger 105 to other locations on surface 111, the display renderer 124 receives touch data 114 indicating the new locations, and it updates the virtual touchscreen graphic 126 accordingly.

In the embodiment shown in FIG. 1, display renderer 124 generates display image 125 of virtual reality environment 123, and it generates virtual touchscreen graphic 126 based on touch data 114. It then integrates virtual touchscreen graphic 126 into display image 125, forming modified display image 130, which is then transmitted to display 103 to be viewed by user 101. In this example, the virtual touchscreen graphic 126 is overlaid onto the display image 125. This is illustrative; one or more embodiments may integrate a virtual touchscreen graphic into a display image in any desired manner, including for example overlaying the graphic onto the image, showing the two in a split screen display, or swapping between one and the other.

In one or more embodiments any or all of communications interface 120, command processor 121, and display renderer 124 may be physically or logically integrated into either the input device 110 or the head mounted device 102. In one or more embodiments any or all of these subsystems may be integrated into other devices, such as other computers connected via network links to the input device 110 or the head mounted device 102. These subsystems may execute on one or more processors, including for example, without limitation, microprocessors, microcontrollers, analog circuits, digital signal processors, computers, mobile devices, smart phones, smart watches, smart glasses, laptop computers, notebook computers, tablet computers, PDAs, desktop computers, server computers, or networks of any processors or computers. In one or more embodiments each of these subsystems may use a dedicated processor or processors; in one or more embodiments combinations of these subsystems may execute a shared processor or shared processors.

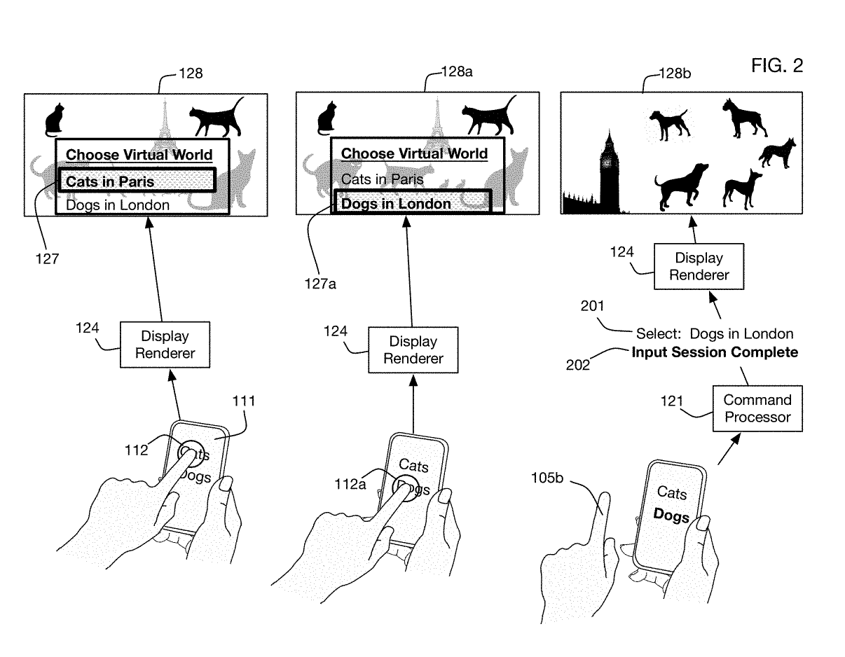

FIG. 2 continues the example illustrated in FIG. 1 to show entry of an input command by the user. As in FIG. 1, the user initially touches location 112 on touch sensitive surface 111 of the input device, which causes display renderer 124 to generate display image 128 containing a virtual touchscreen graphic depicting the touch input. Initially selection 127 is highlighted because it corresponds to location 112. The user then moves the touch to location 112a, and display renderer 124 updates the virtual touchscreen graphic to highlight selection 127a corresponding to the new touch location 112a. The specific form of highlighting shown in FIG. 2 is illustrative; one or more embodiments may use any visual design to indicate whether, where, and how a user is interacting with the touch sensitive surface 111. Finally, the user releases the touch by removing finger 105b from the touch sensitive surface. This touch release is analyzed by command processor 121, which interprets it as an indication that the input selection is complete. Command processor 121 therefore generates an input command 201 with the selection, and transmits this command to display renderer 124. In this illustrative example, the input command selects a different virtual reality environment to be displayed. One or more embodiments may generate input commands that control the display in any desired manner, including for example, without limitation, switching virtual reality environments, selecting or modifying the user's viewpoint in a virtual reality environment, toggling between virtual reality modes and other modes (such as for example an augmented reality mode where camera images are integrated with graphic or text to illustrate or explain aspects of the real environment), or controlling playback or game play. The command processor 121 also generates an Input Session Complete signal 202, since it determines based on the touch release that the user has completed input. The display renderer responds to the command 201 by switching the virtual reality environment and updating the display image to image 128b of the new environment. The display renderer 124 also responds to the Input Session Complete signal 202 by removing the virtual touchscreen graphic from the display image. One or more embodiments may respond to an Input Session Complete signal in any desired manner instead of or in addition to removing the virtual touchscreen graphic from the screen; for example, the graphic may be minimized or greyed out, or it may be moved to a different part of the display screen.

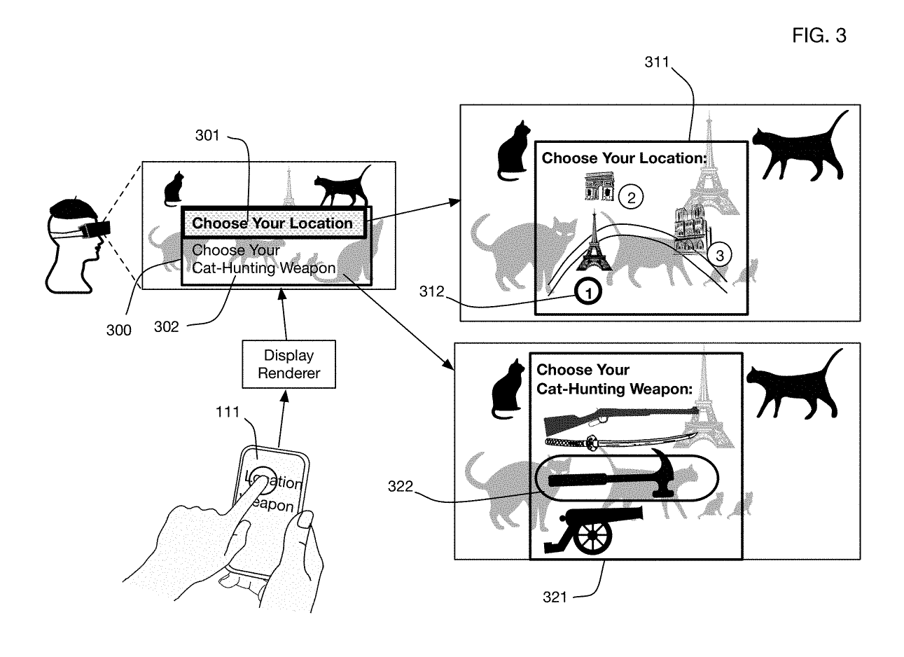

FIG. 3 shows illustrative virtual touchscreen graphics that may be used in one or more embodiments to control various aspects of the display or of the environment from which the display is generated. Initially the virtual touchscreen graphic 300 contains two selectable options 301 and 302. If the user selects option 301, the virtual touchscreen graphic changes to 311, which shows a set of locations in the virtual reality environment that the user can select. For example, if the user selects location 312 (using the touch sensitive surface 111), the new viewpoint of the display image will be based at this location. If the user selects option 302, the virtual touchscreen graphic changes to 321, which provides a choice of weapons for a first-person shooter game. The user can scroll to a selected weapon such as 322 using the touch sensitive surface 111. These examples are illustrative; one or more embodiments may organize virtual touchscreen graphics in any desired manner for any type of user input, and may use the corresponding input commands to control any aspect of the display or the environment.

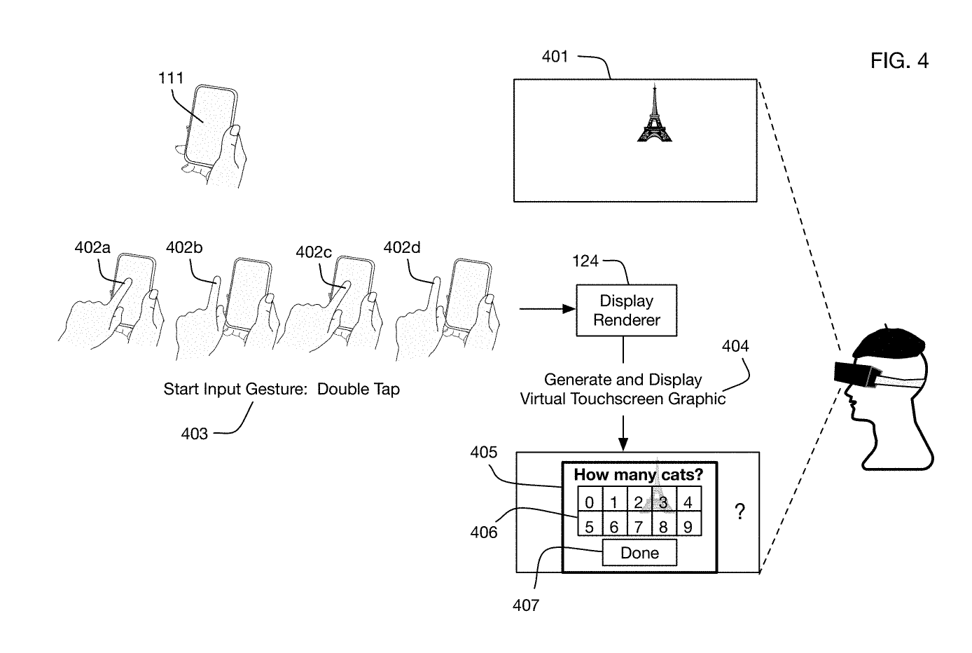

In one or more embodiments, the display renderer generates and displays a virtual touchscreen graphic in response to one or more gestures that indicate that the user is starting input. FIG. 4 illustrates an embodiment with a Start Input Gesture 403 that is a double tap on the touch sensitive surface 111. This gesture is illustrative; one or more embodiments may use any gesture or set of gestures to indicate that user input is starting, and to therefore trigger display of a virtual touchscreen graphic on the display. In FIG. 4, prior to the Start Input Gesture 403 by the user, display image 401 does not have a virtual touchscreen graphic because no input is expected from the user. After the gesture, display renderer 124 generates and displays virtual touchscreen graphic 405 and overlays this graphic onto the display image. In this illustrative example, the virtual touchscreen graphic 405 includes a virtual keyboard 406, in this case with numeric keys. Each key corresponds to a region of the touch sensitive surface 111. The virtual keyboard also includes a Done key 407.

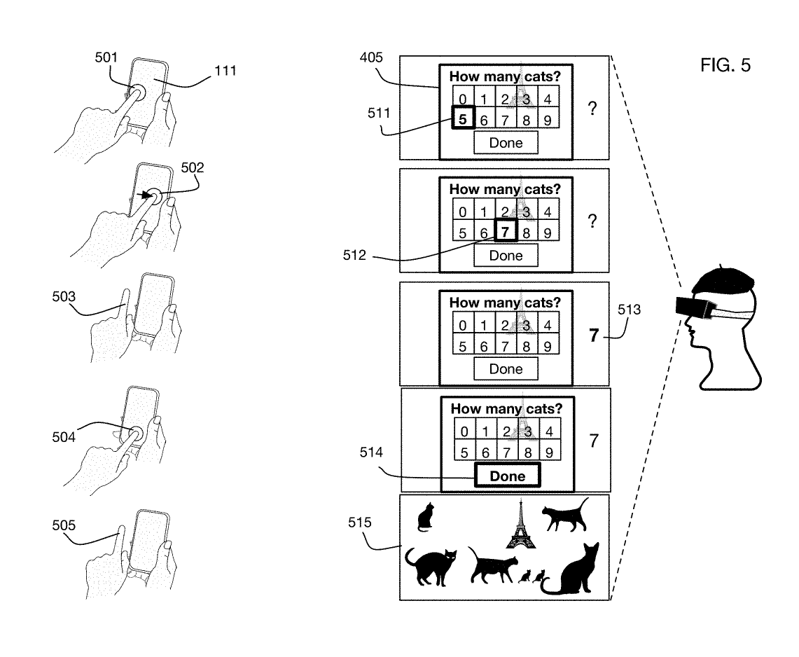

FIG. 5 continues the example of FIG. 4 to show how user touch gestures are interpreted and displayed as keystrokes on the virtual keyboard linked to the touch device. In one or more embodiments, a keystroke or other user input is recognized by the system when the user removes contact from the touch sensitive surface. In some situations, this approach may be more effective than recognizing input at the start of contact, because the user may not know exactly what key (or other input) is being pressed at the beginning of contact, since the user cannot see the touch sensitive surface. Therefore, the user may initiate a touch on the surface, receive feedback on the location of the touch from the virtual touchscreen graphic, slide the contact along the surface (without breaking contact) to reach the desired key, and then remove contact to generate an input keystroke. This approach to user input recognition is illustrated in the sequence of FIG. 5. The user initiates contact at location 501 on touch sensitive surface 111. Since the user cannot see the surface 111, the user may not have pressed the desired key initially. The actual key pressed is highlighted as key 511 on virtual touchscreen graphic 405. The user intended to press the “7” key in this example, so the user slides his or her finger rightward to location 502. The display renderer continuously updates the virtual touchscreen graphic as the finger moves, showing the key under the finger. When the finger reaches location 502, key 512 is highlighted. The user then removes 503 the finger from the surface, indicating input of this key. In response, the command processor recognizes the keystroke, and shows the entered keystroke 513 on the virtual touchscreen graphic. The user then presses location 504 (either initially or by pressing in an arbitrary location and sliding the finger until this key is selected), which highlights the corresponding key 514 on the virtual touchscreen graphic. When the user releases 505 the touch from that location, the system recognizes completion of user input, and reacts by modifying the display to 515. Alternatively, once the selection, i.e., entered keystroke is obtained, the system may accept that input after a predetermined time period, e.g., after a timeout if location 504 is not pressed. The virtual touchscreen graphic is removed from display image 515 since the user input session has completed, as detected by the keystroke 514.

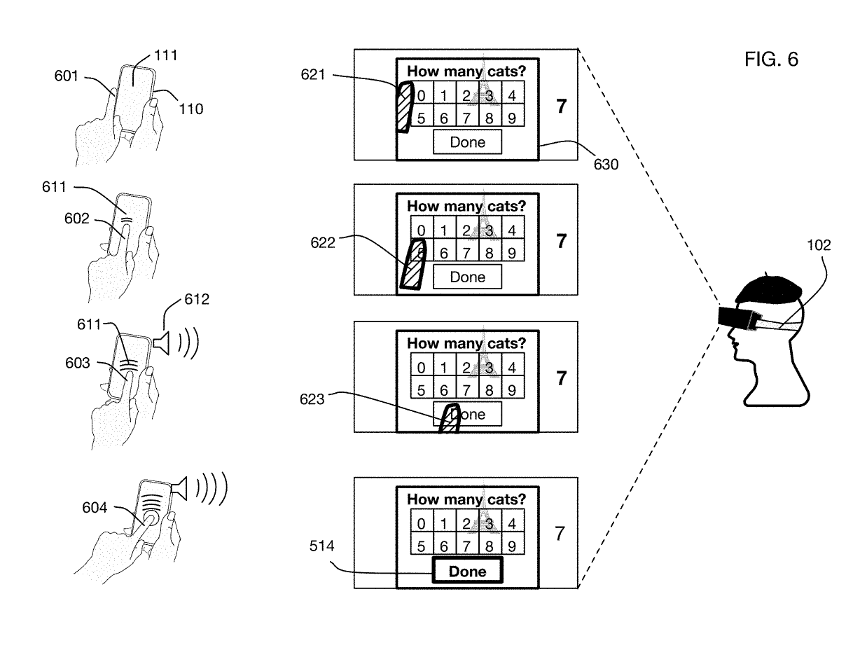

In one or more embodiments, the touch sensitive input device may detect proximity of an item (such as a finger) to the surface, in addition to (or instead of) detecting physical contact with the surface. For embodiments with this capability, the system may alter the virtual touchscreen graphic to show representations of proximal objects in addition to (or instead of) showing physical contact with the surface. For example, as a user hovers his or her finger over a touch sensitive surface, the system may display a representation of the finger location on the virtual touchscreen graphic. FIG. 6 illustrates an embodiment with this feature. Initially the user places finger 601 over the surface 111 without touching the surface. Touch sensitive surface 111 is able to detect proximity of finger 601 to the surface, and the touch data transmitted from 110 includes proximity information for the finger. The virtual touchscreen graphic 630 includes a representation 621 of the hovering finger. As the user moves the finger to location 602, still without contacting the surface, the graphic 622 moves to show the changing finger location.

In one or more embodiments the touch sensitive input device may have one or more more feedback mechanisms in the device. For example, the device may have haptic feedback that can vibrate the entire device or a selected location of the screen. The device may have audio feedback with one or more speakers. For embodiments with this capability, the system may generate and transmit feedback signals to the touch sensitive input device, for example to guide the user to one or more locations on the screen for input. FIG. 6 illustrates an example with device 110 having both a haptic feedback mechanism and a speaker. The system provides feedback to guide the user towards the “Done” button in this example. The specific location or locations associated with feedback are application dependent. In the example of FIG. 6, when the user's finger reaches position 602, the system generates a haptic feedback signal 611 that vibrates the phone slightly. As the user approaches closer to the Done button, the strength of this signal increases. When the user's finger reaches position 603, directly over the button, the haptic signal 611 becomes strong, and in addition an audio signal 612 is sent to play a sound from a speaker on the device. In one or more embodiments the feedback signal or signals may be sent to one more devices instead of or in addition to the touch sensitive input device. For example, speakers on the virtual reality headset 102 may play audio feedback signals. In the example of FIG. 6, the haptic and audio feedback signals increase in intensity as the user moves the finger towards the screen, and then touches the Done button at location 604, which highlights the button 514 on the virtual touchscreen graphic.

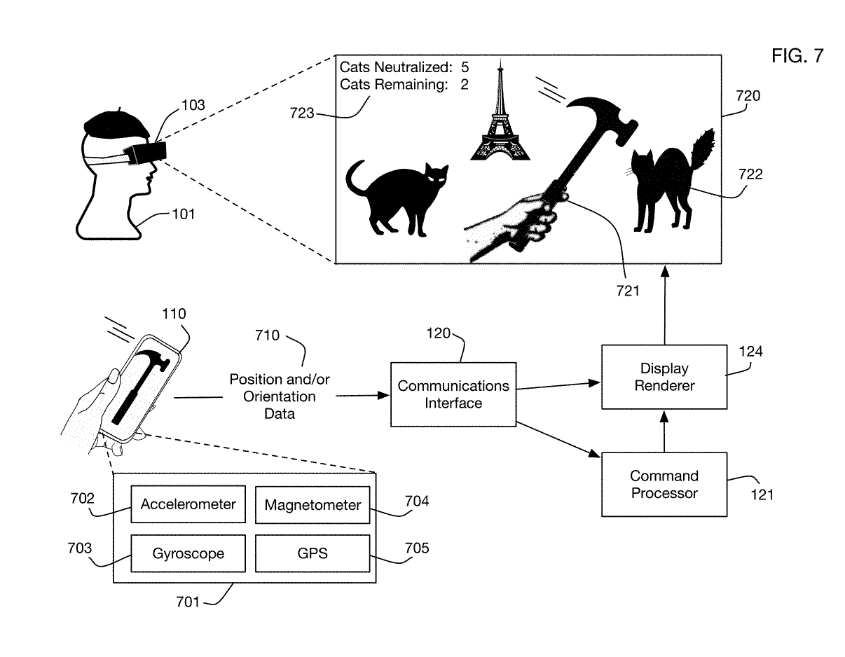

In one or more embodiments the touch sensitive input device may include one or more sensors that measure the position or orientation (or both) of the device. FIG. 7 illustrates an example where device 110 has sensors 701 that include, as examples, accelerometer 702, gyroscope 703, magnetometer 704, and GPS 705. These sensors are illustrative; one or more embodiments may include any sensor or sensors that measure any aspect of or value related to the position or orientation of the device. Position and orientation data 710 from sensors 701 on device 110 may be transmitted to the communications interface 120 and forwarded to the command processor 121 and the display renderer 124. This data may include either or both of position and orientation, on any number of axes. Transformation of the raw sensor data from sensors 701 into position and orientation may be required, using techniques known in the art such as integration of inertial sensor data. Using the position and orientation data 710, the display renderer 124 may for example generate one or more virtual implement graphics, and may integrate these graphics into the display image 720. The virtual implement graphics may for example be tools or weapons in a game, or icons to assist the user in navigating or selecting. The display renderer may generate or modify any aspect of a virtual implement graphic based on position and orientation data, including for example, without limitation, the appearance, size, shape, color, texture, location, orientation, or opacity of the graphic. In the example of FIG. 7, display renderer 124 generates virtual implement graphic 721, with a position and orientation in the virtual world that corresponds to the position and orientation of the input device 110. Thus the user can move and reorient the virtual implement by moving and reorienting the input device 110. The command processor 121 may also receive position and orientation data 710 and use this information to modify or control the display or the virtual environment. For example, the command processor in FIG. 7 may detect contact between virtual implement 721 and virtual element 722, and update the game score 723 accordingly.

While the invention herein disclosed has been described by means of specific embodiments and applications thereof, numerous modifications and variations could be made thereto by those skilled in the art without departing from the scope of the invention set forth in the claims.

What is claimed is:

1. A head mounted display linked to a touch sensitive input device, comprising
a mount configured to be worn on a head of a user;
a display coupled to said mount, and visible to said user when said user wears said mount;
a communications interface configured to receive touch data from a touch sensitive input device, wherein said touch data comprises a location of a touch by said user on a surface of said touch sensitive input device;
a command processor coupled to said communications interface, and configured to generate one or more input commands based on analysis of said touch data;
a display renderer coupled to said communications interface, to said command processor, and to said display, and configured to
generate a virtual touchscreen graphic, wherein pixel positions within said virtual touchscreen graphic correspond to positions on said surface of said touch sensitive input device;
receive said touch data from said communications interface;
based on said touch data, modify said virtual touchscreen graphic to indicate said location of said touch of said user on said surface of said touch sensitive input device;
generate a display image;
integrate said virtual touchscreen graphic into said display image;
receive said one or more input commands from said command processor;
modify said display image based on said one or more input commands;
transmit said display image to said display.

2. The head mounted display linked to a touch sensitive input device of claim 1, wherein
said touch sensitive input device is a touchscreen of a mobile device.

3. The head mounted display linked to a touch sensitive input device of claim 2, wherein
said communications interface is a wireless interface that communicates wirelessly with said mobile device.

4. The head mounted display linked to a touch sensitive input device of claim 1, wherein
said display image is a view of a virtual reality environment;

5. The head mounted display linked to a touch sensitive input device of claim 4, wherein
said display renderer is further configured to perform one or both of
modify said virtual reality environment when said display renderer receives a first input command of said one or more input commands;
modify said view of said virtual reality environment when said display renderer receives a second input command of said one or more input commands.

6. The head mounted display linked to a touch sensitive input device of claim 1, comprising a start input touch gesture;
wherein said display renderer is further configured to generate said virtual touchscreen graphic when said touch data comprises said start input touch gesture.

7. The head mounted display linked to a touch sensitive input device of claim 6, wherein
said command processor is further configured to transmit an input session complete signal to said display renderer when no additional input commands are currently expected from said user;
said display renderer is further configured to remove said virtual touchscreen graphic from said display image when it receives said input session complete signal.

8. The head mounted display linked to a touch sensitive input device of claim 1, wherein
said virtual touchscreen graphic comprises a virtual keyboard;
said modify said virtual touchscreen graphic to indicate said location of said touch of said user on said surface of said touch sensitive input device comprises highlight a key on said virtual keyboard corresponding to said location of said touch.

9. The head mounted display linked to a touch sensitive input device of claim 1, wherein
said display renderer is further configured to update said virtual touchscreen graphic as said user changes said location of said touch while maintaining contact with said surface of said touch sensitive input device.

10. The head mounted display linked to a touch sensitive input device of claim 1, wherein
said command processor is configured to generate one or more of said one or more input commands when said user removes said contact with said surface of said touch sensitive input device.

11. The head mounted display linked to a touch sensitive input device of claim 1, wherein
said touch sensitive input device detects proximity of an item to said touch sensitive surface in addition to contact of said item with said touch sensitive surface;
said location of said touch by said user on said surface of said touch sensitive input device comprises a location of said surface of said touch sensitive input device proximal to said item.

12. The head mounted display linked to a touch sensitive input device of claim 1, wherein
said touch sensitive input device comprises a feedback mechanism that is actuated based on a feedback signal;
said display renderer is further configured to
calculate said feedback signal based on said location of said touch by said user on said surface of said touch sensitive input device compared to a target location;
transmit said feedback signal to said touch sensitive input device.

13. The head mounted display linked to a touch sensitive input device of claim 12, wherein
said feedback mechanism comprises one or both of haptic feedback and audio feedback.

14. The head mounted display linked to a touch sensitive input device of claim 1, wherein
said touch sensitive input device comprises one or more sensors that measure the position or orientation, or both position and orientation, of said touch sensitive input device;
said communications interface is further configured to receive position or orientation data from said one or more sensors;
said display renderer is further configured to
generate a virtual implement graphic;
based on said position or orientation data, modify one or more of an appearance, a location, an orientation, a size, a shape, a color, a texture, and an opacity of said virtual implement graphic;
integrate said virtual implement graphic into said display image.
